(19) United States
(12) Patent Application Publication
(10) Pub. No.: US 2012/0033418 A1
(43) Pub. Date: Feb. 9, 2012

(54) LUMINAIRES USING MULTIPLE QUASI-POINT SOURCES FOR UNIFIED RADIALLY DISTRIBUTED ILLUMINATION

(76) Inventor: Jerome H. Simon, Newton, MA (US)

(21) Appl. No.: 13/166,180

(22) Filed: Jun. 22, 2011

Related U.S. Application Data
(63) Continuation of application No. 12/573,607, filed on Oct. 5, 2009, now abandoned.
Application No. 12/573,607 is a continuation of application No. 11/583,441, filed on Oct. 19, 2006, now Pat. No. 7,597,453.
Application No. 11/583,441 is a continuation-in-part of application No. 11/034,395, filed on Jan. 12, 2005, now Pat. No. 7,677,760.
(60) Provisional application No. 60/728,343, filed on Oct. 19, 2005.
(60) Provisional application No. 60/536,477, filed on Jan. 14, 2004.

(51) Int. Cl. F21V 7/00; F21V 29/00; F21V 21/00

(52) U.S. Cl. 362/235; 362/249.02

(57) ABSTRACT

A luminaire for providing broad uniform surface illumination and sharp cutoff which has at least one quasi point light source, such as an LED, located on an optical axis. There is at least one collimating ring lens which, at least partially surrounds the quasi point light source. The collimating ring projects a radial collimated beam and there is at least one reflective ring, at least partially surrounding the collimating ring lens. The reflecting ring reflects and redirects the collimated radial beam as a canted radial beam through the optical axis. In another embodiment at least one off axis collimating ring lens at least partially surrounds at least one quasi point light source, and projects a canted radial beam away from the optical axis. There is at least one ring reflector which at least partially surrounds the optical axis and is positioned to reflect the canted radial beam toward and through the optical axis. In a further embodiment, at least one linearly collecting reflector at least partially surrounds the quasi point light source and the reflector projects a linear beam onto a substantially conical reflector which redirects the linear beam into a radially directed beam.

### REFERENCE TO RELATED APPLICATIONS

The present application is based on and claims the priority of provisional application, Ser. No. 60/728,343 filed Oct. 19, 2005. The substance of that application is hereby incorporated herein by reference.

The present application is a continuation-in-part of application Ser. No. 11/034,395 filed Jan. 12, 2005. The priority of that application is claimed and the substance of that application is hereby incorporated herein by reference. application Ser. No. 11/034,395 claims the benefit of provisional application 60/535,477 filed Jan. 14, 2004 and the priority of that application is claims and the substance of that application is hereby incorporated herein by reference.

### FIELD OF INVENTION

The present invention relates generally to the lighting field, and, more particularly to providing homogenized light from multiple light sources.

### SUMMARY OF INVENTION

The present invention provides uniform surface illumination from a luminaire containing multiple light sources and homogenized light from multiple light sources.

The present invention further provides sharp cutoff at any desired angle from a luminaire containing multiple light sources.

Also, the present invention provides mixed color from different colored light sources.

Further, the present invention provides broad evenly distributed illumination from a luminaire containing multiple light sources.

### BRIEF DESCRIPTION OF THE DRAWINGS

These and other objects, features and advantages will be apparent from the following detailed description of preferred embodiments taken in conjunction with the accompanying drawings in which:

FIG. 1 is a cross-sectional diagram of the optical components of a lumenair comprised of a single quasi point light surrounded by a collimating lens and a ring reflector for projecting broadly distributed illumination.

FIG. 1a is a cross-sectional diagram of the optical components of a lumenair comprised of multiple quasi point light sources, each surrounded by collimating ring lenses and a ring reflector.

FIG. 1b is a cross-sectional diagram similar to FIG. 1a wherein the ring reflectors are curved in section.

FIG. 1c is a cross-sectional diagram similar to Fig lb further comprising refracting rings.

FIG. 1d is a cross-sectional diagram similar to Fig lb wherein the ring reflectors are canted at different angles in section.

FIG. 2 is a cross-sectional diagram of an off axis radial beam collimator comprised of a quasi point light source surrounded by off axis ring collimator.

FIG. 2a is a cross-sectional diagram similar to FIG. 2 comprising multiple quasi point light sources each surrounded by an off axis ring collimator and further comprised of heat sinks.

FIG. 2b is a cross-sectional diagram similar to FIG. 2a wherein the quasi point light sources are located at differing distances from each other.

FIG. 3 is a cross-sectional diagram similar to FIG. 2 wherein the off axis collimating ring lens is further surrounded by a ring reflector.

FIG. 3a is a cross-sectional diagram similar to FIG. 2a wherein the off axis collimating ring lenses are further surrounded by ring reflectors.

FIG. 4 is a cross-sectional diagram similar to FIG. 2a wherein the off axis collimating ring lenses are further surrounded by refracting rings which in section function as wedge prisms.

FIG. 4a is a cross-sectional diagram similar to FIG. 4 wherein the angles of wedge prisms are different in each prism ring.

FIG. 5 is a cross-sectional diagram similar to Fig la further comprising a second ring reflector.

FIG. 6 is a

FIG. 7 is a cross sectional diagram similar to Fig la wherein the ring reflector is comprised of two conical segments.

FIG. 8 is an elevation view diagram of a lumenaire comprised of radial light projecting modules located at varying distances along the lumenaire.

FIG. 9 is an elevation view diagram of a luminaire similar to that in FIG. 8 wherein the radial light projecting modules are substantially spaced equally.

FIG. 10 is an elevation view diagram of a luminaire similar to that in FIG. 8 wherein each module projects a radial beam, each beam being projected a substantially the same angle.

FIG. 11 is a perspective view of a room containing radially projecting lumenaires positioned and located to illuminate various areas of the room.

FIG. 12 is a cross-sectional view of a luminaire illustrating air flow through a stack of combined multiple quasi point light sources and the heat sinks to which they are attached.

FIG. 12A illustrates a type of heat sink that be used in FIG. 12.

FIG. 12B illustrates a variation of the heat sink described in FIG. 12A.

FIG. 12C illustrates still another variation to the heat sink described in FIG. 12A.

FIG. 12D illustrates a variation to the heat sink shown in FIG. 12b.

FIG. 12E illustrates a type of heat sink that can be used in 12 wherein the heat sink comprises a reflector portion.

### DETAILED DESCRIPTION OF PREFERRED EMBODIMENTS

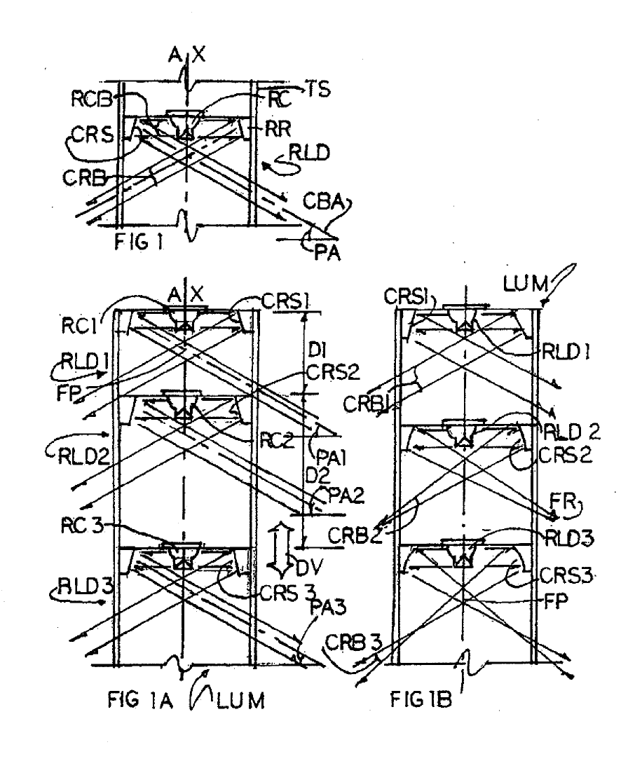

FIG. 1 is a cross-sectional diagram illustrating a single radial light distribution module containing a quasi-point light source such as an LED within a radially collimating ring optic RC, further surrounded by a reflective ring RR having a conically reflecting surface CRS. RC projects a radial collimating beam RCB onto the substantially specular conical surface CRS of RR which in turn reflects canted radial beam CRB1 which has a projected beam angle PA. PA is substantially focused on and passes through the axis AX of RC. The function of RLD is similarly discussed in my co-Pending patent application Ser. No. 11/034,395. RLD is supported within an optically transmissive tube TS.

FIG. 1A is a cross-sectional diagram of a lumenair LUM illustrating multiple RLD modules (shown in FIG. 1) RLD1, RLD2, and RLD3, all having similar radially collimating ring optics RC1, RC2, and RC3 respectively, as well as similar reflective ring surfaces CRS1, CRS2, and CRS3 respectively; therefore, the projected respected beam angles PA1, PA2, and PA3 are substantially equal. FIG. 1A further illustrates that the distance between RLD2 and RLD3 can be the same or different, varying in distance by shifting RLD1, RLD2, and RLD3 in relationship to each other along axis AX as illustrated by graphic arrow DV. Although FIG. 1A illustrates three RLDs, any number of RLDs may be employed along AX at equal and or varying distances from each other.

FIG. 1B is a cross-sectional diagram similar to that of FIG. 1A, illustrating RLD1, RLD2, and RLD3, each having differing cross-section curvatures of the reflecting ring's surfaced CRS1, being substantially flat (as in FIG. 1), CRS2 having a shallow concave surface (round, parabolic, or ellipsoidal), than CRS3. CRS1 reflects radial beam RB1 as canted beam CRB1, the cross-sectional divergence of which is substantially equal to RB1. CRS2 reflects RB2 as convergent, then divergent (in section) CRB2. CRS3 reflects RB3 as beam CRB3, which is more rapidly converging and then diverging than CRB2 due to the greater optical power of CRS3 than CRS2. The spacing and number of RLDs can vary as described in FIG. 1A due to the greater optical power of CRS3 than CRS2. The spacing and number of RLDs can vary as described in FIG. 1A.

FIG. 1C is a cross-sectional diagram illustration of a grouping of RLD modules as shown in FIG. 1A, with the addition of wedge prism rings RWP1 and RWP2, which are substantially concentric and share the same optical axis as RR1. Reflector rings RR2 and RR3 respectively and wedge prism rings RWP1 and RWP2 have the function of altering the radial beam pitch angle PA2 and PA3, as illustrated as RA2 and RA3. Angle A (AA) represents the cross-sectional angle between the faces of the wedge prism ring (PWR). The greater the angle, the greater the deviation in beam direction; the approximate function of a wedge prism is, for each degree of angle difference, the beam deviation equals one-half degree. Further, the wedge prism function is to bend the beam in the direction of the wider part of the prism.

FIG. 1D is a cross-sectional diagram of a partial lumenair LUM comprised of three RLD modules RLDI, RLD2, and RLD3 similar to those illustrated in FIG. 1. Although each of the reflective surfaces CRS1, CRS2, and CRS3 has a different respective cant angle A1, A2, and A3, A1 is most acute; therefore the angle PA1 (formed by the reflected beam angle BC1, and GP, a plane perpendicular to AX) is most acute. Cant angle A2 or CRS2 is less acute than A1 and therefore PA2 is less acute than PAL It follows that if A3 is less acute than A2, then PA2 is less acute than PA2.

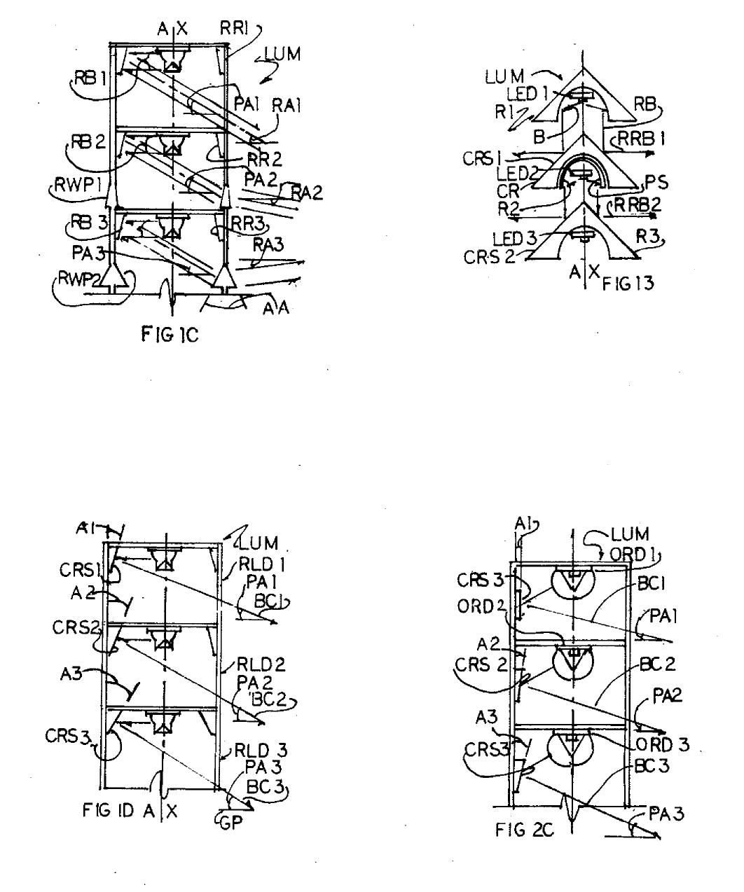

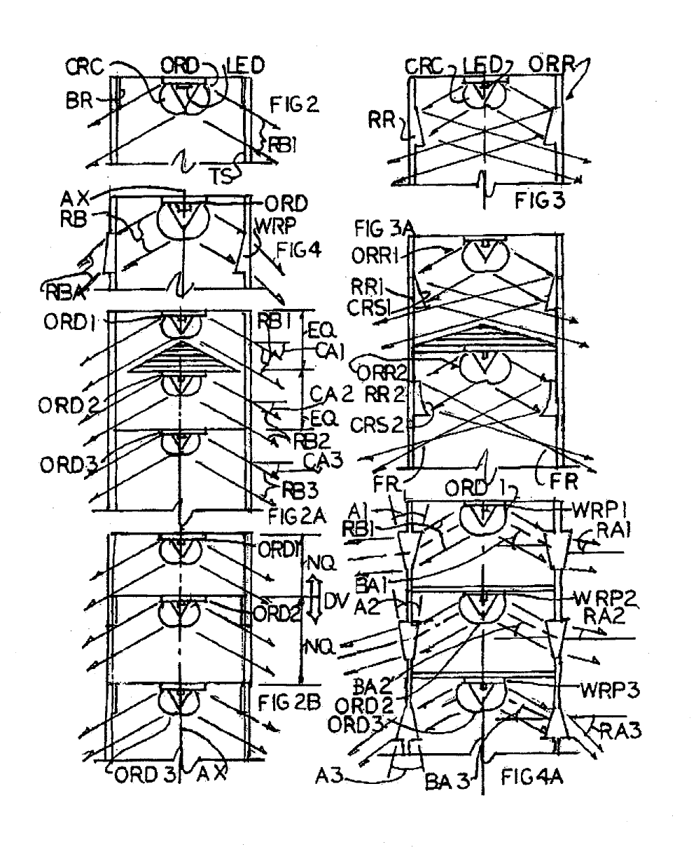

FIG. 2 is a cross-sectional diagram of an off-axis radial beam projector comprised of a quasi-point light source at least partially surrounded by an off-axis ring collimator CRC, projecting canted radial beam RB1 through a clear tubular support TS which is not essential for the light distribution provided by off-axis radial distributor ORD. Baffle ring BR blocks visual brightness emanating from CRC providing full cutoff of light that is not projected from the lens. The function of ORD is further elaborated and described in my co-pending application Ser. No. 11/034,395.

FIG. 2A is a cross-sectional diagram of an off-axis radial beam projector comprised of multiple ORDs, ORD1, ORD2, and ORD3, each projecting radial beams RB1, RB2, and RB3 respectively, each having substantially equal cant angles CA1, CA2, and CA3 respectively. The distance between ORD1 and ORD2, and the distance between ORD2 and ORD3, is equal. HST is a typical heat sing shown attached to LED of ORD2, shaped as a cone so as not to obstruct RB1.

FIG. 2B is a cross-sectional diagram of a device similar to that shown in FIG. 2A, differing in that the distance between ORD1 and ORD2 and the distance between ORD2 and ORD3 can be equal or be different by shifting one ORD in relation to another along axis AX.

FIG. 2C is a cross-sectional diagram of a partial lumenair LUM, comprised of ORD modules ORD1, ORD2, and ORD3, similar to those shown in FIG. 2. The relationship between the cant angles A1, A2, and A3 of CRS1, CRS2, and CRS3 respectively to the relationship of PA1, PA2, and PA3 is described and elaborated on in FIG. 1D.

FIG. 3 is a cross-sectional diagram of an off-axis radial beam projector similar to the one illustrated in FIG. 2 with the addition of reflector ring RR, the function and description of which is elaborated upon in FIG. 1.

FIG. 3A illustrates a radial beam projector containing two ORR modules ORR1 and ORR2 as described in FIG. 3. The cross-sectional surfaces of RR1 and RR2, CRS1 and CRS2 function and differ from each other in substantially the same way as CRS1 and CRS2 of FIG. 1A.

FIG. 4 is a cross-sectional diagram illustrating an ORD module similar to that shown in FIG. 2 with the addition of wedge prism ring WPR, which alters the cross-sectional direction of radial beam RB as radial beam RBA.

FIG. 4A is a cross-sectional diagram of a grouping of ORD modules, ORD1, ORD2, and ORD3, projecting RB1, RB2, and RB3 (all canted at the same angles) onto and through surrounding wedge prism rings WRP1, WRP2, and WRP3 respectively. Angle A1 of WRP1 is greater that A3 of WRP2 and therefore the variation between the sectional beam angle BA1 and its angle RA1 once refracted (bent) by RWP1 is greater than the variation between the sectional beam angle BA2 and its angle RA2 once refracted (bent) by RWP1. Further, the angle A3 of RWP3 is in the reverse direction of both A2 of RWP2 and A3 of RWP3 causing the cross-sectional difference between BA3 and its angle once refracted RA3 to be greater than the difference between BA1 and RA1, and BA3 and RA3. This is further elaborated on in FIG. 1 with the explanation of the function of the wedge prism (ring). The radial collimator RC of FIG. 1 can also be used in substitution of CRC in FIG. 3 with WPR of FIG. 4.

FIG. 5 is a cross-sectional diagram of two RLD modules, RLD1 and RLD2, similar in function to those of RLD of FIGS. 1, 1A, or FIG. 1B or FIG. 1C with the addition of retro reflector rings RER1 and RER2 respectively. RER1 and RER2 (which at least partially surround AX) reflect rays CRB1 and CRB2 as rays DRB1 and DRB2 respectively, which project in the same radial direction as CRB1 and CRB2 (that are not reflected by RER1 and RER2) respectively. Although 2 RCD modules are shown, any number of modules can be combined.

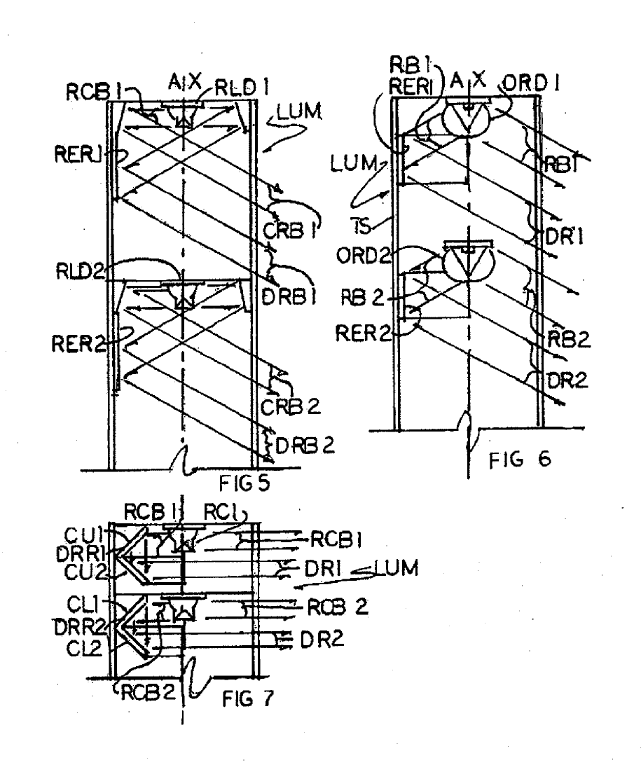

FIG. 6 is a cross-sectional diagram of an off axis radial beam projector comprising two ORD modules ORD1 AND ORD2 projecting canted radial beams RB1 and RB2 respectively. Reflector rings RER1 and RER2 which partially surround AX, reflect a portion of ORD1 and ORD2 as partial canted radial beams DR1 and DR2 respectively in the same radial direction as RB1 and RB2 respectively.

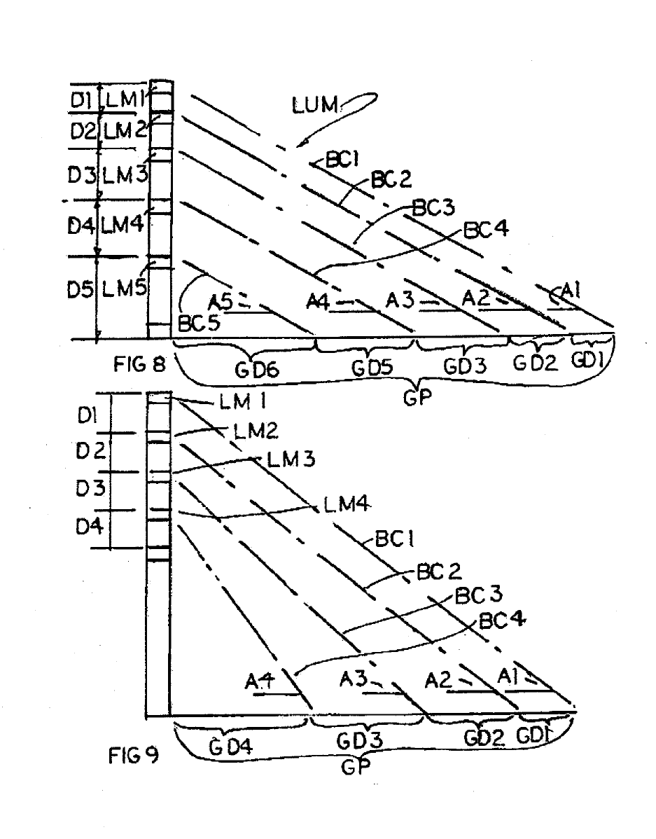

FIG. 7 is a cross-sectional diagram of two modules RC1 and RC2, each containing a quasi-point light source and a radially collimating ring optic similar to RC of FIG. 1, with the addition of compound reflectors DRR1 and DRR2 respectively. DRR2 and DRR2 are comprised of two truncated conical reflectors CU1 and CU2, and CL1 and CL2, joined at the large diameters so that rays RCB1 are reflected by CU1 onto CU2 and exit as rays DR1, which are projected in the same radial direction as rays CB1. Similarly rays RCB2 are reflected by CL1 onto CL2, which are reflected by CL3 as rays DR2.

FIG. 8 is an elevation view diagram of a lumenair LUM comprised of radial light distribution modules LM1, LM2, LLM3 and LM5, mounted within tubular support TS. All the LM modules can be of a single type as any of the those shown in FIGS. 1, 1A, 1B, 1C, 2, 2A, 2B, 3, 3A, 4, 4A, 5, 6, or 7, or be a combination of any of the radial light distribution modules shown; however, FIG. 8 is primarily illustrating the use of multiples of a single type of radial light distribution module. The distance D1, D2, D3, D4, and D5 between the modules increases between each of the modules as the distance of the modules decreases from the ground (surface) plane GP. Each module shown projects a radial beam having a beam center BC1, BC2, BC3, BC4, and BC5 respectively each at substantially the same angle A1, A2, A3, A4, and A5 to GP. Therefore, the distances between the modules D1, D2, D3, D4, and D5 are substantially the same ratios to the distances at GD1, GD2, GD3, GD4, and GD5 between the beam centers that strike GP. Referencing the reverse square law, it becomes necessary to provide an increasingly higher concentration of light further from the source, in order to maintain uniform brightness as the distance from the source increases. One way of achieving uniform brightness is to increase the density of projected beams as the distance from the source increases. This is clearly illustrated in the system described in this FIG. 8) and is further illustrated in FIGS. 1A and 1B.

FIG. 9 is an elevation view of a lumenair LUM mounted on a ground plane GP comprised of a grouping of radial light distribution modules LM1, LM2, LM3, and LM4 (mounted within TS). The distance D1, D2, D3, and D4 between and relative to the modules is substantially equal. Each LM module projects a radial beam (their respective centers are represented by BC1, BC2, BC3, and BC4) and are all projected at different angles (A1, A2, A3, and A4) to GP, the angles becoming progressively steeper to the ground plane from A1 through A4. One way this can be achieved by using the optical system described in FIGS. 1C, 4C, 1D, and Z1. Also differing reflective surfaces as represented by CRS1, CRS2, and CRS3 of FIG. 1B can be incorporated to change the beam spread of any or all the LM modules illustrated in FIG. 9 (or in FIG. 8). Generally, the LM module that is closest to the ground plane (LM4) would contain the CR5 surface that creates the widest beam divergence. Conversely, the LM module that is furthest from GP (LM1) would contain the CRS surface that creates the narrowest beam divergence. The substantially concentric areas of GP that receive projected light from LM1, LM3, LM3, and LM4 are GD1, GD2, GD3, and GD4 which become progressively wider as they get closer to the lumenair LUM.

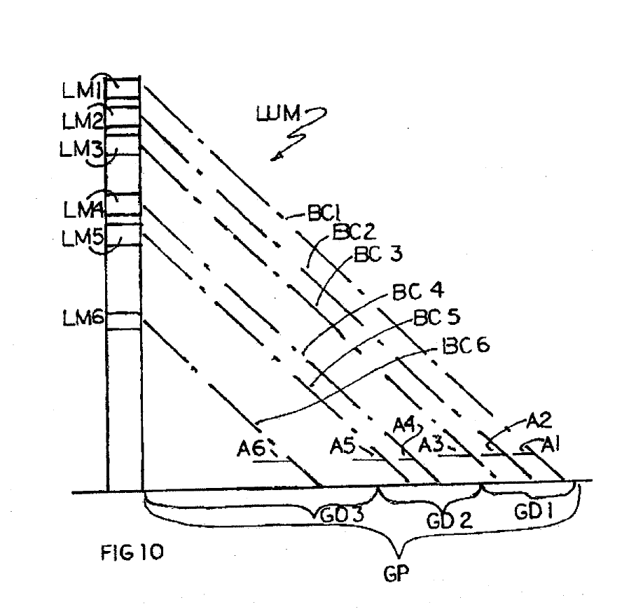

FIG. 10 is an elevation view of a lumenair LUM comprised of LM modules LM1, LM2, LM3, LM4, LMS, and LM6 projecting radial beams (represented by beam centers BC1, BC2, BC3, BC4, BC5, and BC6) onto GP. In order to achieve relatively even brightness throughout BP, LM1, LM2, and LM3 are stacked closely together, projecting beams A4 and AS which are wider than LM1, LM2, and LM3. LM6 projects the widest beam, A6, onto GD3. BC1, BC2, BC3, BC4, BC5 and BC6 are all projected at equal angles represented by A, A1, A2, A3, A4, and A5. Although FIGS. 8, 9, and 10 illustrate LUMs mounted to GP, LUMs can be inverted and mounted to ceilings or be mounted to walls to spread indirect illumination.

FIG. 11 Is a perspective view of a room RM containing four LUM lumenairs. Each lumenair is comprised of one or several types of radial beam modules as described in FIGS. 1 through 7.

LUM1 is a ceiling-mounted IR lumenair having an up-light indirect distribution as illustrated and described in FIGS. 8, 9, and 10, and a down-light distribution DR provided by inverted LUM modules as those LUMs that provide the up-light distribution.

LUM2 is a lumenair mounted substantially perpendicular to wall W providing substantially 180° downward illumination on picture P. Lum2 is comprised of an optical system similar to that of either or FIGS. 5, 6, and 7.

LUM3 is a floor lamp providing up-light UL.

LUM4 is a table T lamp providing down-light to T.

FIG. 11 illustrates a limited number of total uses for the optical configurations in this Patent Application. Others include outdoor poles, bollards, path lights, wall packs, etc.

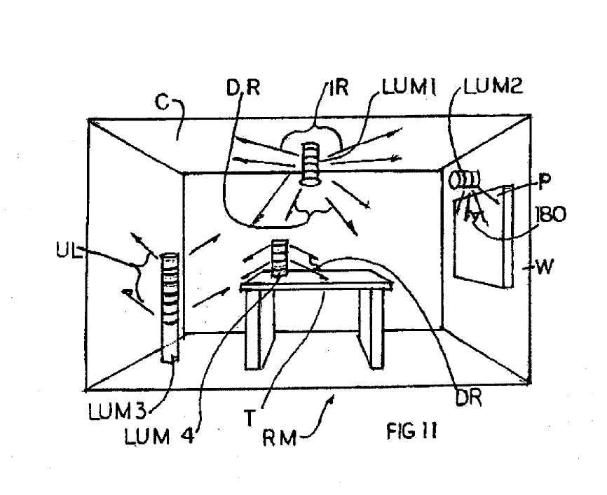

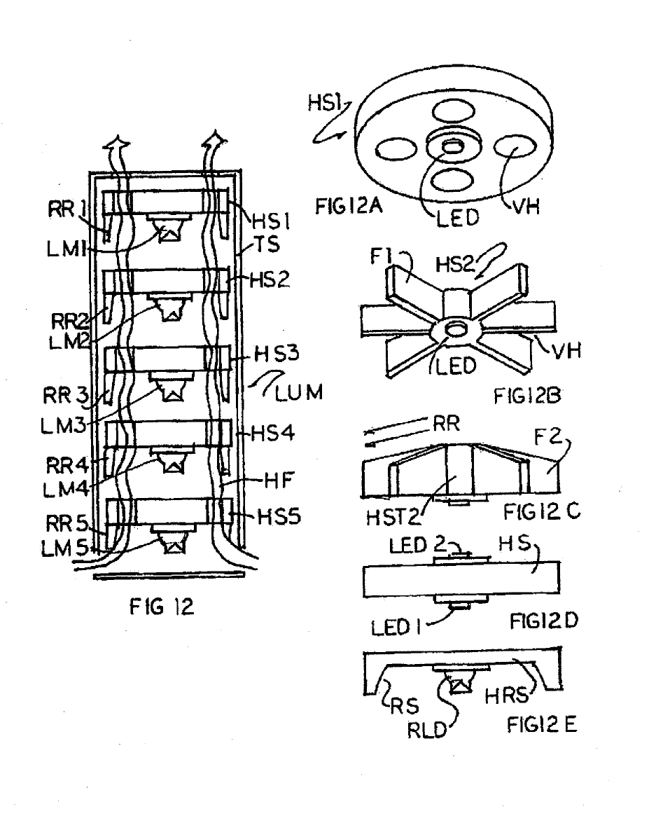

FIG. 12 is a sectional view of a lumenair LUM containing stacked groups of any combination of LMs or ORDs as described in FIGS. 1 through 7 or any stacked series of quasi-point sources such as LEDs. Module LM is mounted to a heat sink HS11, HS2, HS3, HS4, and HS5. In the case of LEDs, this is necessary to maintain lumen output and LED light. Each heat sink is constructed in such a way as to allow air to pass through from one to another represented by HF rising through HS5 to and through HS1. LUM of FIG. 12 is also comprised of tubular form TS which substantially encompasses the stack of modules LM1 through LM5 and their associated heat sinks HS1 through HS5. TS acts to provide a chimney effect for HF rising through LUM.

FIG. 12A is a three-dimensional diagram of one type of heat sink that may be utilized as an example of the lumenair shown in FIG. 12. The quasi-point source LED is mounted to HS1. Surrounding the mount of LED on HS1 are vent holes VH in HS1, allowing air to rise through.

FIG. 12B is a three-dimensional diagram of another type of heat sink HS2. HS2 contains a mount for an LED and radiating fins that allow air to pass through the space between the fins VS.

FIG. 12C is a side view of a heat sink HST2 which is similar to HS2 of FIG. 12B, differing in that the fins F2 are tapered so as not to obstruct canted radial beam RR projected by an LM or ORD (not shown).

FIG. 12D is a side view diagram of two quasi-point light sources LED1 and LED2 mounted back to back on the same flat heat sink HS.

FIG. 12E is a section view diagram of a heat sink HSR on which is mounted a quasi-point light source RLD that can or can not be surrounded by a collimating ring, further surrounded by a reflective surface RS.

FIG. 13, is a cross-sectional diagram of a lumenair comprised of 3 quasi-point light sources LED1, LED2, and LED3, each at least partially surrounded by a reflector system R1, R2C, and R3 respectively. The function of reflective surface PS1 of R1 (which may be parabolic, ellipsoidal, or spherical) is to collect rays B emanating from LED1 and redirect them as RB onto the reflective surface CRS1 of substantially conical reflector CR which in turn reflects RB as radial beam RRB1. The function of reflectors R2 to R3 is similar to that described between R2 and R1. R2C is comprised of two elements, a light collimating element R2 similar in description and function to R1, and a conical reflecting element CR (both on the same optical axis). R3 is a single element combining a collecting surface RL3 and a substantially conical surface CRS2. CRS and or CRS2 can be straight in section (as shown) or convex or concave.

It is to be understood that the above-described embodiments are simply illustrative of the principles of the invention. Various and other modifications and changes may be made by those skilled in the art which will embody the principles of the invention and fall within the spirit and scope thereof.

1-19. (canceled)

20. A luminaire for providing optically controlled illumination from stacked multiple quasi point light sources comprising:
a stack of multiple quasi point light sources which are LEDs that project light outwardly;
a heat sink onto which at least one LED is attached forming a stack of heat sinks, at least one heat sink having openings through which air can flow;
said stack of heat sinks mounted within a substantially tubular shaped housing, at least a portion of the housing fabricated from material through which light from the LEDs can pass through.

21. A luminarie as in claim 20 wherein said stack of heat sinks are located within a tubular housing forming a column in which a chimney effect is generated and through which heat rises and passes through within said housing through one heat sink to another.

22. A luminaire as in claim 20 wherein at least one heat sink comprises fins, said openings in said heat sinks being created and disposed between fins, said fins radiating outwardly from the center of said heat sinks.

23. A luminaire as in claim 20 wherein the shape of said heat sinks are such so as not to obstruct a beam projected by another LED that is mounted to another heat sink within said stack of heat sinks.

24. A luminaire as in claim 20 wherein the optic is a refractive ring is mounted to and disposed on the perimeter of said heat sink so as not to obstruct air flowing through the housing.

25. A luminaire as in claim 20 wherein the heat sinks are attached to the walls of the housing.

26. A luminaire as in claim 25 wherein the tube is open at least on one end.

27. A luminaire as in claim 20 wherein an optic is so disposed in relationship to at least one LED to redirect light emanating from the LED that would otherwise impinge on and be obstructed by a heat sink.

28. A luminaire as in claim 20 wherein an optic at least partially surrounds and directs light from the LED as a beam through the wall of the tubular housing.

29. A luminaire as in claim 28 wherein the optic is a reflecting ring is mounted to and disposed on the perimeter of said heat sink so as not to obstruct air flowing through the housing.

30. A luminaire as in claim 29 wherein said reflective ring is part of and functions as a heat sink.
